(19) United States
(12) Patent Application Publication
(10) Pub. No.: US 2026/0346384 A1
(43) Pub. Date: Nov. 5, 2026

(54) SEALING RING DEFORMATION DEVICE

(71) Applicant: Trelleborg Sealing Solutions Germany GmbH, Stuttgart (DE)

(72) Inventor: Jan KOLODZIEJ, Fellbach (DE)

(73) Assignee: Trelleborg Sealing Solutions Germany GmbH, Stuttgart (DE)

(21) Appl. No.: 19/714,360

(22) Filed: Jun. 19, 2026

Related U.S. Application Data
(63) Continuation of application No. PCT/EP2024/083550, filed on Nov. 26, 2024.

(30) Foreign Application Priority Data
Dec. 21, 2023 (DE) 102023136306.9

(51) Int. Cl. B23P 19/04

(52) U.S. Cl. CPC B23P 19/047

(57) ABSTRACT

A method for elastically deforming a circular sealing ring to a circumscribed-circle diameter which is smaller than the outside diameter of the undeformed, circular sealing ring has the following steps: deforming the circular sealing ring to form a waisted sealing ring having two opposite end loops and a waist therebetween having two opposite waist portions by pressing two portions of the circular sealing ring together until the two portions form the two waist portions; and clamping the two waist portions against one another between a convex, in particular, circular-cylindrical, deflection element and a counter bearing element and bending the two loops around the convex deflection element without relative displacement of the waist portions clamped against one another in order to form a kidney-shaped sealing ring, the circumscribed-circle diameter of which is smaller than the outside diameter of the undeformed, circular sealing ring.

### CROSS-REFERENCE TO RELATED APPLICATIONS

This application is a continuation of International application number PCT/EP2024/083550 filed on Nov. 26, 2024, which has published as WO 2025/131581A1 , and which claims priority to German application number DE 10 2023 136 306.9 filed on Dec. 21, 2023, the entire contents of which are fully incorporated herein with these references.

### DESCRIPTION

### Field of the Invention

The present invention relates to a method for elastically deforming a circular sealing ring to a circumscribed-circle diameter which is smaller than the outside diameter of the undeformed, circular sealing ring, and to an associated sealing ring deformation device.

### Background of the Invention

In order to insert a circular sealing ring into an internal annular groove in an opening, the circular sealing ring must first of all be elastically deformed to a circumscribed-circle diameter which is smaller than the diameter of the opening. When the sealing ring held in the deformed shape is positioned within the opening, the sealing ring is released, with the result that, on account of its inherent elasticity, it expands into the original circular shape and, in the process, automatically inserts itself into the annular groove.

FIGS. 5a, 5b show a conventional sealing ring deformation device 100 for elastically deforming a circular sealing ring 101 into a kidney shape, the circumscribed-circle diameter of which is smaller than the outside diameter of the undeformed, circular sealing ring 101. The sealing ring deformation device 100 has four rollers 102-105, of which three rollers 102-104 are arranged in a fixed location at 3 o'clock, 6 o'clock and 9 o'clock along the circumscribed circle thereof. In its outer end position, which is shown in FIG. 5a, a fourth roller forms a tangent to the inside of the circumscribed circle at 0 o'clock and is mounted in such a way that it can be displaced radially inward beyond the center of the circumscribed circle in the direction of the central roller 103 as per the double arrow.

A circular sealing ring 101, the inside diameter of which is equal to or slightly larger than the circumscribed-circle diameter, is inserted into the sealing ring deformation device 100, and its inside forms a tangent with the three rollers 102-104 and its outside forms a tangent with the fourth roller 105, which is situated in its outer end position (FIG. 5a). The fourth roller 105 is then pushed into its inner end position, as a result of which the associated sealing ring portion is pulled radially inward by the fourth roller 105 and inverted from a convex to a concave curvature. The sealing ring 101 is thereby bent in a U shape around the two lateral rollers 102, 104 and the fourth roller 105 in order to form a kidney-shaped sealing ring 101′, the circumscribed-circle diameter of which is smaller than the outside diameter of the undeformed, circular sealing ring 101.

With this known mounting principle, the deformation of the sealing ring is thus due to radial compression by means of the displaced fourth deflection roller and due to two lateral deflection rollers for defining the kidney-shaped contour. The deformation that occurs during this process, involving 3-point bending, takes place contrary to the natural (circular) resistance of the sealing ring, and therefore this mounting principle is not suitable for sealing rings made of rigid/brittle materials.

In contrast, it is the underlying object of the present invention to specify an alternative method for elastically deforming a circular sealing ring into a kidney shape, which method is suitable, in particular, also for relatively rigid/brittle materials, as compared with the conventional method, and also to specify an associated sealing ring deformation device.

### SUMMARY OF THE INVENTION

According to the invention, this object is achieved by a method comprising the following method steps:
a) deforming the circular sealing ring to form a waisted sealing ring having two opposite end loops and a waist therebetween having two opposite waist portions by pressing two portions of the circular sealing ring together until the two portions form the two waist portions; and
b1) clamping the two waist portions against one another between a convex, in particular, circular-cylindrical, deflection element and a counter bearing element and bending the two loops around the convex deflection element without relative displacement of the waist portions clamped against one another in order to form a kidney-shaped sealing ring, the circumscribed-circle diameter of which is smaller than the outside diameter of the undeformed, circular sealing ring; or
b2) bending one, first loop around a convex, in particular, circular-cylindrical, deflection element, clamping the two waist portions against one another between the convex deflection element and a counter bearing element and bending the other, second loop around the convex deflection element without relative displacement of the waist portions clamped against one another in order to form a kidney-shaped sealing ring, the circumscribed-circle diameter of which is smaller than the outside diameter of the undeformed, circular sealing ring.

According to the invention, the two waist portions of the waisted sealing ring are clamped against one another at the latest before the bending over of the second loop, and therefore no relative movement of the two waist portions transversely to the clamping direction or in the longitudinal direction of the waisted sealing ring is possible. Particularly in the case of sealing rings made of rigid/brittle materials, a relative movement of the two waist portions occurring while the loop(s) is (are) being bent over can render the sealing ring unusable.

In particular, the method according to the invention offers the following advantages. The convex deflection element permits a significantly larger bending radius, thereby enabling sealing rings made of more rigid/brittle materials to be deformed into the kidney shape than in the conventional method. Bending the two loops around the convex deflection element imposes less stress on the material than 3-point bending against the circular resistance of the sealing ring. Method variant b2) allows the sealing ring a defined free space while the first loop is being bent over, and it reduces the constrained deformation. Tests show that the method according to the invention has significant potential for a higher assembly/deformation rate than in the conventional method.

The two bent-over loops are preferably each fixed by means of a fixing element arranged inside the loop, in particular, at the loop end remote from the waist. The shape of the kidney-shaped sealing ring is preferably fixed exclusively by the deflection element and the fixing elements.

As a particular preference, in step a), the circular sealing ring is deformed into the waisted sealing ring with two loops of different lengths, as a result of which the waist is not formed and clamped in the center of the longitudinally deformed sealing ring but eccentrically. The length ratio of the two loops of different lengths is advantageously between 2.5 to 1 and 1.5 to 1, in particular, 2 to 1.

Preferably, in step b1) and b2), the convex deflection element is moved toward the counter bearing element in order to clamp the waist portions therebetween. The counter bearing element can thus be arranged in a fixed location.

In a preferred method variant, one or each of the two loops is bent around the convex deflection element by pressing that loop branch of the respective loop which is on the outside with respect to the convex deflection element around the convex deflection element by means of a pressure element engaging on the outside of the loop. By way of example, the pressure element is mounted in such a way as to be movable in a linear or arcuate manner around the deflection element.

In another preferred method variant, one or each of the two loops is bent around the convex deflection element by pulling that loop branch of the respective loop which is on the inside with respect to the convex deflection element, or the free loop end of the respective loop, the end remote from the waist, around the convex deflection element by means of a tension element engaging on the inside of the loop. By way of example, the tension element is mounted in such a way as to be movable in a linear or arcuate manner around the deflection element. In an advantageous further development of this method variant, in step b1) and b2), a bent-over loop is guided by means of its outer loop branch along the outside of a shaping contour, which is, in particular, concavely curved to match the desired outer contour of the kidney-shaped sealing ring. Especially if the sealing ring does not have a symmetrical cross section but has insides and outsides with different profiles, it is possible in this way to counteract twisting of the sealing ring by contact with the shaping contour.

The invention also relates to a sealing ring deformation device for elastically deforming a circular sealing ring to a circumscribed-circle diameter which is smaller than the outside diameter of the undeformed, circular sealing ring, comprising a convex, in particular, circular-cylindrical, deflection element and a counter bearing element, which can be moved relative to one another in order to clamp therebetween a waist of the sealing ring deformed in a waisted manner, and two pressure or tension elements, which are arranged on both sides of the convex deflection element and can each be moved between an initial position and an end position in order to bend two end loops of the sealing ring, deformed in a waisted manner, in a kidney shape around the convex deflection element.

The tension element is preferably arranged inside a loop of the sealing ring, deformed in a waisted manner, in order to pull the respective loop around the deflection element, and the pressure element is arranged outside a loop of the sealing ring, deformed in a waisted manner, in order to press the respective loop around the deflection element. In this case, a pressure side of the pressure element, which side presses on the loop, can advantageously be of concave, in particular, circular-cylindrical, design, counteracting twisting of the sealing ring.

In a particularly preferred embodiment, the counter bearing element is designed as a first lever arm, which at one end is pivotably mounted on the housing side and, in a closed pivoted position, clamps the waist of the sealing ring deformed in a waisted manner against the convex deflection element. In an advantageous further development of this embodiment, the pressure element can be designed as a second lever arm, which at one end is pivotably mounted on the free end of the first lever arm and, in a closed pivoted position, presses the loop around the convex deflection element.

The deflection element and the tension element are preferably secured on a mounting plate, which is rotatably mounted in a bearing opening in a bearing housing. The bearing housing can advantageously have a fixed circumferential wall, which extends along part of a circumference of the mounting plate and the partially circular inside of which extends the bearing opening upward.

Further advantages and advantageous configurations of the subject matter of the invention can be found in the description, the drawing and the claims. The aforementioned features and the features presented below in more detail below can each likewise find use individually or together in any combination. The embodiments shown and described should not be construed as a comprehensive list, but rather have a merely exemplary character for the purpose of explaining the invention.

### BRIEF DESCRIPTION OF THE DRAWINGS

In the drawings:

FIGS. 1a-1e show the individual method steps of a first method according to the invention for elastically deforming a circular sealing ring into a kidney shape;

FIGS. 2a-2f show the individual method steps of a second method according to the invention for elastically deforming a circular sealing ring into a kidney shape;

FIG. 3 shows a sealing ring deformation device according to the invention for elastically deforming a circular sealing ring into a kidney shape;

FIGS. 4a-4f show the individual method steps for elastically deforming a circular sealing ring into a kidney shape by means of the deflection tool shown in FIG. 3; and

FIGS. 5a, 5b show the individual method steps of a conventional method for elastically deforming a circular sealing ring into a kidney shape.

### DETAILED DESCRIPTION OF THE PREFERRED EMBODIMENTS

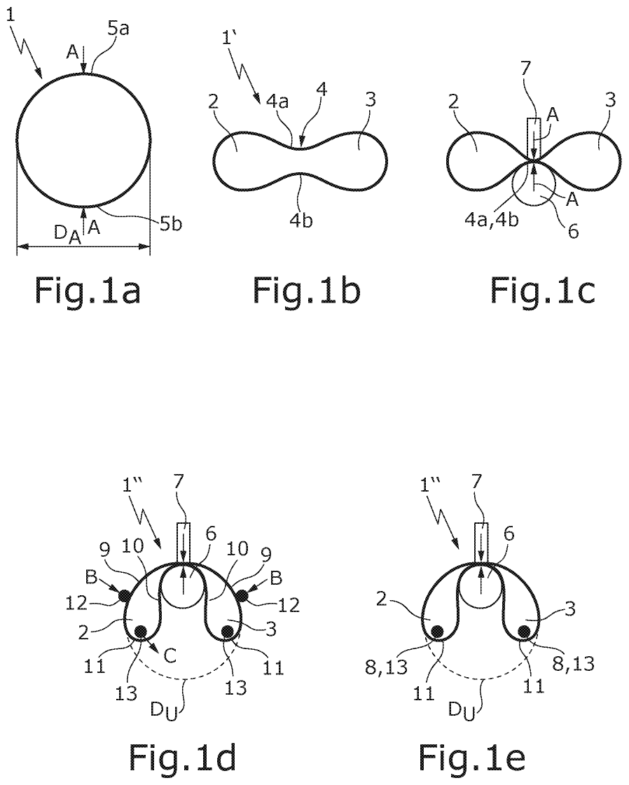

FIGS. 1a-1e shows the individual method steps of a method for elastically deforming a circular sealing ring 1 with an outside diameter D_{A} into a kidney shape, the circumscribed-circle diameter D_{U} of which is smaller than the outside diameter D_{A} of the undeformed, circular sealing ring 1.

The circular sealing ring 1 shown in FIG. 1a is deformed radially inward, by compressing two opposite, in this case diametrically opposite, portions 5a, 5b, to form a waisted sealing ring 1′ (FIG. 1b). The waisted sealing ring 1′ has two opposite end loops 2, 3 and a waist 4 therebetween having two opposite waist portions 4a, 4b, which are formed by the two portions 5a, 5b that are pressed together.

The two waist portions 4a, 4b are clamped against one another between a convex, in this case circular-cylindrical, deflection element 6 and a counter bearing element 7 (FIG. 1c), as indicated by the two arrows A. For this purpose, at least one of these two elements 6, 7 is moved towards the other element in order to clamp the two waist portions 4a, 4b therebetween. The deflection element 6 can be a roller that is fixed or mounted in such a way as to be freely rotatable. The counter bearing element 7 can be arranged in a fixed location, for example, such that only the deflection element 6 is moved.

The two loops 2, 3 are then bent around the deflection element 6 without relative displacement of the waist portions 4a, 4b, which are clamped against one another (FIG. 1d), in order to form a kidney-shaped sealing ring 1″, the circumscribed-circle diameter D_{U} of which is smaller than the outside diameter D_{A} of the undeformed, circular sealing ring 1. The bending of the two loops 2, 3 around the deflection element 6 is accomplished either by pressing that loop branch 9 of a loop 2, 3 which is on the outside with respect to the deflection element 6 around the deflection element 6 by means of a pressure element 12, which is in this case in the form of a pin and engages on the outside of the loop, as indicated by the arrow B, or by pulling that loop branch 10 which is on the inside with respect to the deflection element 6, or the free loop end 11 of a loop 2, 3, the end remote from the waist, around the deflection element 6 by means of a tension element 13, which is in this case in the form of a pin and is arranged inside the loop 2, 3, as indicated by the arrow C. By way of example, the pressure and tension elements 12, 13 are mounted in such a way as to be movable in a linear or arcuate manner around the deflection element 6.

Finally, a respective fixing element 8 resting against the free loop end 11 is arranged inside the bent-over loops 2, 3 (FIG. 1e) in order to fix the loops 2, 3 in their bent-over form and to keep the two waist portions 4a, 4a clamped against the deflection element 6. Where present, the tension element 13 can simultaneously also perform the function of the fixing element 8. The shape of the kidney-shaped sealing ring 1″ is now fixed by the deflection element 6 and the two fixing elements 8 but not yet also by the counter bearing element 7.

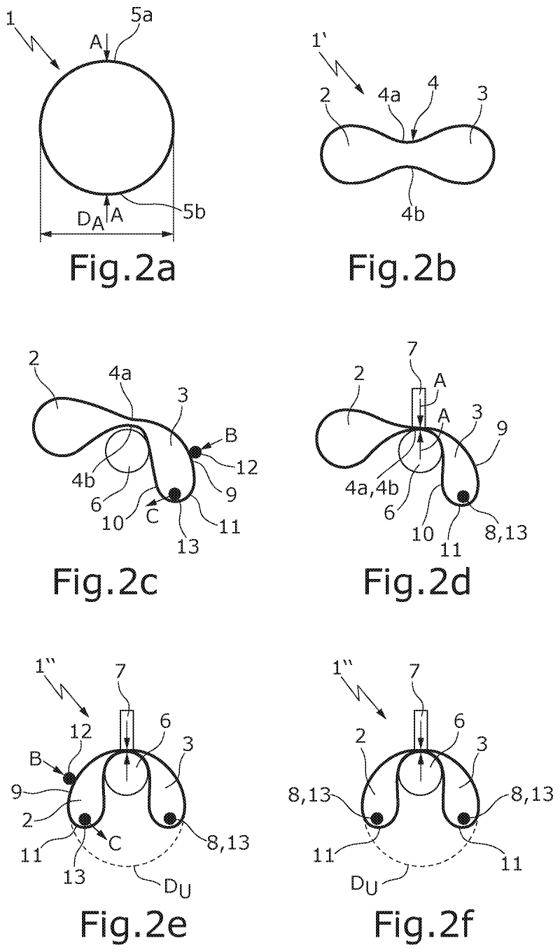

FIGS. 2a-2f show the individual method steps of an alternative method for elastically deforming a circular sealing ring 1 with an outside diameter D_{A} into a kidney shape, the circumscribed-circle diameter D_{U} of which is smaller than the outside diameter D_{A} of the undeformed, circular sealing ring 1.

The circular sealing ring 1 shown in FIG. 2a is deformed radially inward, by compressing two opposite, in this case diametrically opposite, portions 5a, 5b, to form a waisted sealing ring 1′ (FIG. 2b). The waisted sealing ring 1′ has two opposite end loops 2, 3 and a waist 4 therebetween having two opposite waist portions 4a, 4b, which are formed by the two portions 5a, 5b that are pressed together.

The loop 3 which is on the right in FIG. 2b is bent around a convex, in this case circular-cylindrical, deflection element 6 (FIG. 2c), and the two waist portions 4a, 4b are then clamped against one another between the deflection element 6 and a counter bearing element 7 (FIG. 2d), as indicated by the two arrows A. For this purpose, at least one of these two elements 6, 7 is moved towards the other element in order to clamp the two waist portions 4a, 4b therebetween. The deflection element 6 can be a roller that is fixed or mounted in such a way as to be freely rotatable. The counter bearing element 7 can be arranged in a fixed location, for example, such that only the deflection element 6 is moved.

The left-hand loop 2 is then also bent around the deflection element 6 without relative displacement of the waist portions 4a, 4b, which are clamped against one another (FIG. 2e), in order to form a kidney-shaped sealing ring 1″ , the circumscribed-circle diameter D_{U} of which is smaller than the outside diameter D_{A} of the undeformed, circular sealing ring 1. The bending of the two loops 2, 3 around the deflection element 6 is accomplished either by pressing that loop branch 9 of a loop 2, 3 which is on the outside with respect to the deflection element 6 around the deflection element 6 by means of a pressure element 12, which is in this case in the form of a pin and engages on the outside of the loop, as indicated by arrows B, or by pulling that loop branch 10 which is on the inside with respect to the deflection element 6, or the free loop end 11 of a loop 2, 3, the end remote from the waist, around the deflection element 6 by means of a tension element 13, which engages on the inside of the loop, as indicated by arrows C. By way of example, the pressure and tension elements 12, 13 are mounted in such a way as to be movable in a linear or arcuate manner around the deflection element 6.

At the latest at this time, a respective fixing element 8 resting against the free loop end 11 is arranged inside the bent-over loops 2, 3 (FIG. 2f) in order to fix the loops 2, 3 in their bent-over form and to keep the two waist portions 4a, 4a clamped against the deflection element 6. Where present, the tension element 13 can simultaneously also perform the function of the fixing element 8. The shape of the kidney-shaped sealing ring 1″ is now fixed by the deflection element 6 and the two fixing elements 8 but not yet also by the counter bearing element 7.

Instead of being pin-shaped, as shown in FIGS. 1 and 2, pressure elements 12 can also extend along the outer loop branch 9 and can be concavely curved to match the desired outer contour of the kidney-shaped sealing ring 1″.

Instead of being of the same length, as shown in FIGS. 1 and 2, the two loops 2, 3 can also be of different lengths if the waist 4 is not formed and clamped in the center of the longitudinally deformed sealing ring 1 but eccentrically.

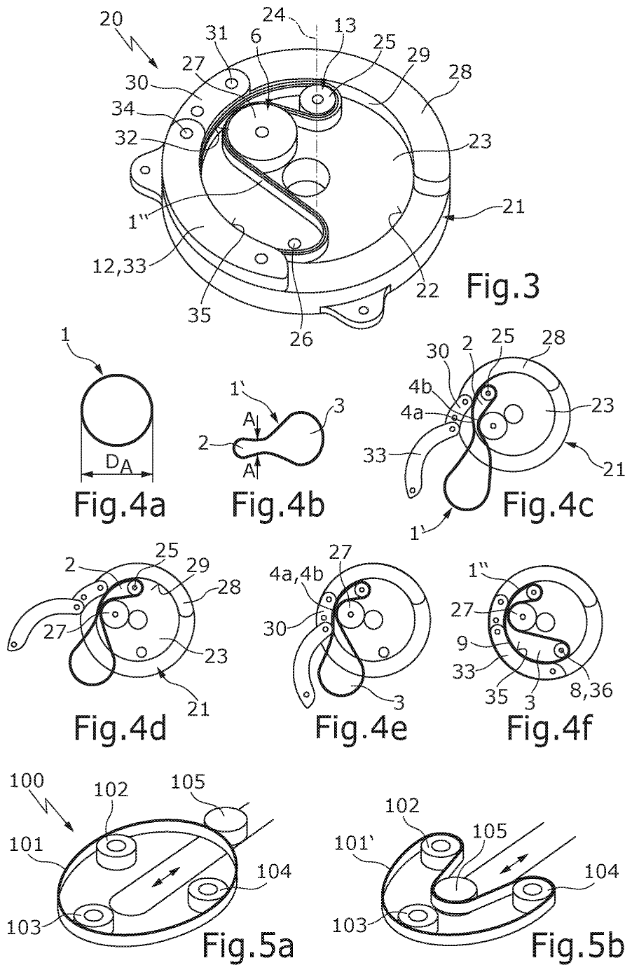

The sealing ring deformation device 20 shown in FIG. 3 serves to elastically deform a circular sealing ring 1 into a kidney shape and comprises a bearing housing 21, in this case an annular bearing housing, in the bearing opening 22 of which a mounting plate 23, in this case a circular mounting plate, is mounted so as to be rotatable about an axis of rotation 24. On its upper side, the mounting plate 23 has a tension element 13 in the form of a small roller 25, an insertion opening 26 situated opposite, in this case diametrically opposite, the small roller 25 with respect to the axis of rotation 24, and a convex deflection element 6 in the form of a large roller 27. The large roller 27 is arranged between the small roller 25 and the insertion opening 26 in the circumferential direction of the mounting plate 23, in the present case closer to the small roller 25. The rollers 25, 27 can be mounted so as to be freely rotatable or can be fixed.

Above the mounting plate 23, the bearing housing 21 has a fixed, in this case annular-segment-shaped circumferential wall 28, which extends along part of a circumference of the mounting plate 23 and the partially circular inside (shaping contour) 29 of which extends the bearing opening 22 in the axial direction or upward. Adjoining the circumferential wall 28 is a first, in this case circular-arc-shaped, lever arm 30, which is mounted on the bearing housing 21 in such a way as to be pivotable about an axis 31 parallel to the axis of rotation 24 and has a partially circular inside 32. A pressure element 12 in the form of an, in this case circular-arc-shaped, second lever arm 33 is mounted on the free end of the first lever arm 30 in such a way as to be pivotable about an axis 34 parallel to the axis of rotation 24, said lever arm having a partially circular inside (shaping contour) 35. As in the present case, the first lever arm 30 can be shorter than the second lever arm 33. In the closed positions, which are shown in FIG. 3, the two lever arms 30, 33 extend along part of the circumference of the mounting plate 23 and, with their partially circular insides 32, 35, extend the bearing opening 22 in the axial direction or upward. The circumferential wall 28 and the closed lever arms 30, 33 extend over about 270° along the mounting plate 23. The two lever arms 30, 33 can be pivoted outward out of their closed positions into a respective open position, as shown in FIG. 4c.

The individual method steps for elastically deforming a circular sealing ring 1 by means of the sealing ring deformation device 20 into a kidney shape, the circumscribed-circle diameter of which is smaller than the outside diameter of the undeformed, circular sealing ring 1, are described below.

FIG. 4a shows the circular sealing ring 1 with outside diameter D_{A}.

As an option, the sealing ring 1′ can be pre-deformed-by elastic compression-into an elongate pear shape with a narrow loop and a wide loop 2, 3 (FIG. 4b). The wide loop 3 is preferably about twice as long as the narrow loop 2.

The lever arms 30, 33 are opened, and the mounting plate 23 is rotated in the bearing housing 21 until the small roller 25 is at the level of the end of the circumferential wall 28 adjacent to the lever arms. The narrow loop 2 of the pre-deformed sealing ring 1′ is then placed around the small roller 25 (FIG. 4c), wherein the wide loop 3 projects outward from the bearing housing 21.

The mounting plate 23 is then rotated clockwise by about 45° in the bearing housing 21, with the result that the narrow loop 2 is taken along by the small roller 25 and the narrow loop 2 is thereby bent around the large roller 27 (FIG. 4d). The outer loop branch 9 of the narrow loop 2 is guided along the partially circular inside 29 of the circumferential wall 28 and rests against it. A waist with two opposite waist portions 4a, 4b is formed between the two loops 2, 3. The small roller 25 forms a fixing element 8 which fixes the narrow loop 2.

The first lever arm 30 is pivoted inward into its closed position and is fixed in this position, thereby clamping the two waist portions 4a, 4b against one another between the large roller 27 and the first lever arm 30 (FIG. 4e).

The second lever arm 33 is then also pivoted inward into its closed position and fixed in this position, thereby pressing the wide loop 3 around the large roller 27 without relative displacement of the waist portions 4a, 4b that are clamped against one another. The outer loop branch 9 of the wide loop 3 comes to rest against the partially circular inside 35 of the second lever arm 33. Finally, the bent-over wide loop 3 is fixed by means of a fixing element 8, in this case in the form of a small roller 36, inserted into the insertion opening 26 (FIG. 4f).

The resulting kidney-shaped sealing ring 1″ has a circumscribed-circle diameter which corresponds to the opening diameter of the bearing opening 22 and is smaller than the outside diameter D_{A} of the undeformed, circular sealing ring 1.

The guidance or contact of the sealing ring 1 on the partially circular insides 29, 32, 35 counteracts twisting of the sealing ring 1, especially if the sealing ring does not have a symmetrical cross section but has insides and outsides with different profiles.

Instead of the two lever arms shown, just a single lever arm, which performs both the clamping and the bending, or even more second lever arms for the successive bending of a loop are also conceivable.

To mount the kidney-shaped sealing ring 1″ in an internal annular groove in an opening in a machine component, the two lever arms 30, 33 are opened. The mounting plate 23 together with the sealing ring 1″ is removed from the bearing housing 21 and positioned within the opening in the machine component. The large roller 27 is then removed from the mounting plate 23, thereby releasing the sealing ring 1″ , which, on account of its inherent elasticity, expands into the original circular shape and, in the process, automatically inserts itself into the annular groove.

What is claimed is:

1. A method for elastically deforming a circular sealing ring to a circumscribed-circle diameter which is smaller than the outside diameter of the undeformed, circular sealing ring, the method comprising the following steps:
a) deforming the circular sealing ring to form a waisted sealing ring having two opposite end loops and a waist therebetween having two opposite waist portions by pressing two portions of the circular sealing ring together until the two portions form the two waist portions; and
b1) clamping the two waist portions against one another between a convex deflection element and a counter bearing element and bending the two loops around the convex deflection element without relative displacement of the waist portions clamped against one another in order to form a kidney-shaped sealing ring, the circumscribed-circle diameter of which is smaller than the outside diameter of the undeformed, circular sealing ring; or
b2) bending one, first loop around a convex deflection element, clamping the two waist portions against one another between the convex deflection element and a counter bearing element and bending the other, second loop around the convex deflection element without relative displacement of the waist portions clamped against one another in order to form a kidney-shaped sealing ring, the circumscribed-circle diameter of which is smaller than the outside diameter of the undeformed, circular sealing ring.

2. The method as claimed in claim 1, wherein the two bent-over loops are each fixed by means of a fixing element arranged inside the loop or at the loop end remote from the waist.

3. The method as claimed in claim 1, wherein, in step a), the circular sealing ring is deformed into the waisted sealing ring with two loops of different lengths.

4. The method as claimed in claim 3, wherein the length ratio of the two loops of different lengths is between 2.5 to 1 and 1.5 to 1.

5. The method as claimed in claim 1, wherein, in step b1) and b2), the convex deflection element is moved toward the counter bearing element in order to clamp the waist portions therebetween.

6. The method as claimed in claim 1, wherein one or each of the two loops is bent around the convex deflection element by pressing that loop branch of the respective loop which is on the outside with respect to the convex deflection element around the convex deflection element by means of a pressure element engaging on the outside of the loop.

7. The method as claimed in claim 1, wherein one or each of the two loops is bent around the convex deflection element by pulling that loop branch of the respective loop which is on the inside with respect to the convex deflection element, or the free loop end, remote from the waist, of the respective loop, around the convex deflection element by means of a tension element engaging on the inside of the loop.

8. The method as claimed in claim 7, wherein, in step b1) and b2), a bent-over loop is guided by means of its outer loop branch along the outside of a shaping contour, which is concavely curved to match the desired outer contour of the kidney-shaped sealing ring.

9. A sealing ring deformation device for elastically deforming the circular sealing ring to the circumscribed-circle diameter which is smaller than the outside diameter of the undeformed, circular sealing ring, for carrying out the method as claimed in claim 1, comprising:
the convex deflection element and the counter bearing element, which can be moved relative to one another in order to clamp therebetween a waist of the sealing ring deformed in a waisted manner; and
two pressure or tension elements, which are arranged on both sides of the convex deflection element and can each be moved between an initial position and an end position in order to bend two end loops of the sealing ring, deformed in a waisted manner, in a kidney shape around the convex deflection element.

10. The sealing ring deformation device as claimed in claim 9, wherein the deflection element is designed as a roller.

11. The sealing ring deformation device as claimed in claim 9, wherein the tension element is arranged inside a loop of the sealing ring, deformed in a waisted manner, in order to pull the respective loop around the deflection element.

12. The sealing ring deformation device as claimed in claim 11, wherein the tension element is designed as a roller.

13. The sealing ring deformation device as claimed in claim 9, wherein the pressure element is arranged outside a loop of the sealing ring, deformed in a waisted manner, in order to press the respective loop around the deflection element.

14. The sealing ring deformation device as claimed in claim 13, wherein a pressure side of the pressure element, which pressure side presses on the loop, is of concave design.

15. The sealing ring deformation device as claimed in claim 9, wherein the counter bearing element is designed as a first lever arm, which at one end is pivotably mounted on the housing side and, in a closed pivoted position, clamps the waist of the sealing ring deformed in a waisted manner against the convex deflection element.

16. The sealing ring deformation device as claimed in claim 15, wherein the pressure element is designed as a second lever arm, which at one end is pivotably mounted on the free end of the first lever arm and, in a closed pivoted position, presses the loop around the convex deflection element.

17. The sealing ring deformation device as claimed in claim 10, wherein the deflection element and the tension element are secured on a mounting plate, which is rotatably mounted in a bearing opening in a bearing housing.

18. The sealing ring deformation device as claimed in claim 17, wherein the bearing housing has a fixed circumferential wall, which extends along part of a circumference of the mounting plate and the partially circular inside of which extends the bearing opening in the axial direction.
